(19) United States
(12) Patent Application Publication
(10) Pub. No.: US 2018/0139374 A1
(43) Pub. Date: May 17, 2018

(54) SMART AND CONNECTED OBJECT VIEW PRESENTATION SYSTEM AND APPARATUS

(71) Applicant: Hai Yu, Woodbury, MN (US)

(72) Inventor: Hai Yu, Woodbury, MN (US)

(21) Appl. No.: 15/350,109

(22) Filed: Nov. 14, 2016

(51) Int. Cl. H04N 5/232; H04N 21/218; H04N 21/4223; H04N 5/247

(52) U.S. Cl. CPC H04N 5/23206; H04N 5/23296; H04N 5/247; H04N 21/4223; H04N 21/21805

(57) ABSTRACT

System and apparatus for providing service of view presentation focusing on automatically tracked object to service users, where each service user has individually specified target object of interest. The system comprises a field overviewing device to provide high resolution field overview image and to support object tracking and positioning; a telescopic mast device to support variable filed overviewing configurations and to provide a mobile system platform; and a computerized view presentation service center to provide individually specified target object view presentation to connected service users via a networked communication device. The system further comprises focused object viewing device to provide individual target object tracking in focused view presentations. A mobile platform for the focused object viewing device, like robot or drone, can advance such target object tracking and viewing presentations in more dynamic environments. The system may further comprise camera arrays to provide high-dimensional dynamic object view presentation.

### TECHNICAL FIELD

The present invention is in the field of automatic camera view presentation controls, pertains more particularly to system and apparatus for providing quality focused view presentation over moving objects in sports and performance activities. The invented automatic object tracking view presentation system aims at supporting performance recording and skill assessment for high quality self-training, remote-training, and video sharing purposes.

### BACKGROUND

In sports and performances, it is highly desirable to have a way to help people reviewing their performance with sufficiently focused motion details in order to improve their skills during training practice and contests. Camera systems and mobile displaying device are more and more intensively involved in such training assistant system. The cameras produce video streams that can be displayed on user's smartphone and tablet computers. Both trainees and their coaches can review the recorded performance and exhibition to find out the gap and improvement potentials in the trainee's performance skills.

However, traditional performance recording processes usually need a professional cameraman to manually operate the orientation and zoom of the camera in order to have a performer presented in the camera view with sufficient focuses on motion details. Such assistant services are hardly available or affordable for common exerciser and nonprofessional players on a regular basis. Existing automatic sport recording systems have been widely used in sport broadcasting, but they are too expensive and are hardly available in common public sport stadiums or activity places.

The auditorium cameras capture view image over the activity field. However, in conventional auditorium camera systems, each camera can only cover limited view region and users have to switch among many camera views to watch different regions of an activity field. Some other system combines all the camera images to generate one wide-angle view image. This enable the audience to watch the whole performance but it loss the ability to focus at single performer that moves around the activity field. Such systems are usually fixed to a stadium and are not portable to provide variable sports and performance object focused video recording deployments.

Some other systems, like Soloshot, are portable and they can provide object following video recording function. However, users have to inconveniently carry such systems with them to wherever the sport activity field or the performance stage is. Such systems are not able to be shared in object following view presented among multiple users. In the situation of activity over a large area, the setup of such system becomes a cumbersome headache in order to achieve a sufficient coverage over the target objects.

In order to provide the services of automatic object tracking view presentation system with convenient general public access, this invention discloses view presentation control system that can provide high quality object-focused view presentation to track user specified object automatically in view. This invented auto-focusing view presentation system has a portable or mobile platform that enables it to be deployed to any sport activity environment. The platform can also automatically move like a robot to adjust its location with respect to target objects to achieve a best view presentation quality. The invented system is truly public sharing system that is capable to provide smart object following view presentation to all the connected users that have their individually target object specified to be tracked in view. None of the uses are required the carry such system but to have a view presentation device, like smartphone and table computer, to wirelessly connected to the invented system, or to connect remotely through Internet.

The invented view presentation system has variable configuration capability to further provide focused object tracking view using focused object viewing devices that have camera capturing the view solely on the target object by aligning their aim-point of the camera with the position and motion of the target object. Such focused object viewing devices can be equipped with mobile tracking platform, like robots, vehicles or drones, to surround the target object in motion. Such focused object viewing devices can further provide high-dimension dynamic view presentation using camera arrays.

The invented automatic object tracking view presentation system integrates telescopic mast device and support platform, field overviewing device, focused object viewing device, computerized view presentation service center, as well as networked communication device and power supply device. It is able to provide automatic object viewing applications including: general object locating; target object specification from user's view presentation devices; automatic object following and view focusing control; view presentation video playing and recording; etc.

First, the telescopic mast system and platform provide convenient deployment solution to the invented system. The telescopic mast system is compact when not in use such that it is easy to be put in cars when transporting to destinations. The telescopic mast can be elevated to achieve a high view point in deployment in order to provide best field overview and object positioning and tracking results. The telescopic mast system comprises a mast base system to provide support and stability to the whole system. The mast base system can be a mobile platform and such mobile platform can be a robotic platform to provide automatic and controllable object surrounding view presentation to closely follow moving target object in sport events. The telescopic mast system further comprises Pan-Tilt unit (PTU) to relatively adjust the pan angle, tile angle and rotation angle of its head to provide an optimized orientation to the field overviewing device installed on its head.

Second, the field overviewing device used in this invention provides high resolution field overview image and video stream over a sport activity field. The view presentation service center processes the field overview image to support target object specification, object positioning, object tracking view presentation, etc. For each connected service user, a customer view frame is defined inside the field overview image. The customer view frame specifies the area inside the field overview image where the service user wants to have focused view presentation. The size and position of the customer view frame are determined based on view navigation data comprising user's view navigation inputs and, most importantly, the automatic object tracking data. By recognizing the position and size of a target object, the position and size of the customer view frame gets updated accordingly after a new field overview image is generated such that the image of the target object is sufficiently covered and centered inside the field overview image area that is enclosed by the customer view frame.

Third, the invented system can further integrate focused object viewing device to achieve high quality and dynamic object view presentation over individual target object. An exemplary embodiment of such focused object viewing device is a Pan-Tilt-Zoom (PTZ) camera device attached to the telescopic mast platform that can be controlled by the view presentation service center to automatically adjust the orientation of its lens such that its aim-point locates at the target object's position in the activity ground. Its zooming ratio can also be controlled to automatically adjust to a target object presentation ratio in the final view image. The PTZ camera can further be installed on a mobile platform, like robot, vehicle or drone, to achieve enhanced object surrounding video tracking presentation. In this case, the position and motion of the mobile platform is controlled by the view presentation service control to an optimal relative position and relative orientation with respect to the target object as well as at an optimal relative motion to the target object. Additionally, an exemplary embodiment of such focused object viewing device comprises camera array devices to achieve high-dimensional dynamic object presentation in view, like 360-degree view, 3D or 4D object view, etc.

Next, the invented view presentation system comprises networked communication device to provide data communications between subsystems and to connect to service users. Ethernet cables and network switch are typically used to connect all the devices to the view presentation service center for data communication. Wireless communication devices, including router and WiFi access points, are used to connect service users to the view presentation service system onsite. Internet and mobile communication devices are typically used to connect the view presentation service system to remote view presentation devices through Internet and other extended networks. The invented view presentation system has power supply system to provide electric power. In outdoor deployments, battery and generator based power supply system are typically used.

The invented automatic object tracking view presentation system provides services at public activity places. Users can access the service from their mobile device, like smartphones, and select desired target object to follow in presented view. Users can watch and review performance video transmitted or recorded on their mobile devices, or from any network connected computerized view presentation devices, like computers, pad, smartphone, stadium large screen, etc.

The invented automatic object tracking view presentation system aims at supporting performance recording and assessment in activities like sports, performances and exhibitions. It provides a high-quality auto-focus and auto-following view presentation solution to satisfy the needs of performance assessment and professional video sharing in training and sport activities.

### SUMMARY OF THE INVENTION

The following summary provides an overview of various aspects of exemplary implementations of the invention. This summary is not intended to provide an exhaustive description of all of the important aspects of the invention, or to define the scope of the inventions. Rather, this summary is intended to serve as an introduction to the following description of illustrative embodiments.

Illustrative embodiments of the present invention are directed to a system with a computer readable medium encoded with instructions for providing automatic object tracking view presentation for public service applications.

In a preferred embodiment of this invention, a field overviewing device is installed at the head of a telescopic mast device and platform. The telescopic mast device enables elevation adjustment of the field overviewing device to achieve variable view angle to an activity field. The telescopic mast platform provides support and stability to the whole system and even mobility and automation. A computerized view presentation service center is attached to the platform to provide device controls, system managements and object tracking view presentation service functionalities. A networked communication device and a power supply device are also attached to the platform to construct the invented automatic object tracking view presentation system. Public service users get connected to the view presentation service system via the communication methods provided by the networked communication device using their view presentation devices.

The height of the telescopic mast device can either be adjusted manually, or it comprises electro-mechanic actuation unit to control the height through user inputs or by computer programs. In some embodiment of this invention, a PTU is used at the head of the telescopic mast to provide pan angle, tilt angle and rotation angle adjustment capabilities that changes the orientation of the filed overviewing device with respect to the activity field. In some other embodiment of this invention, the PTU can either be controlled using remote-control devices or by computer programs on the view presentation service center. The telescopic mast platform can be fixed or on a mobile platform including wheeled robotics, vehicles, etc.

Wide-angle cameras or camera array devices are typically used for the field overviewing device that captures high resolution overview image over an activity field. For each connected service user, a customer view frame is defined inside the field overview image. The customer view frame specifies a closed geometric area inside the field overview image where the service user wants to have focused view presented. The size and position of the customer view frame are determined based on user's view navigation inputs and, most importantly, on automatic object tracking data. By recognizing the position and size of a target object, the position and size of the customer view frame gets updated accordingly after a new field overview image is generated such that the image of the target object is sufficiently covered and centered inside the field overview image area that is enclosed by the customer view frame. The image data inside the customer view frame are extracted from the field overview image and are processed into customer view image, which it then transmitted to user's view presentation device for presentation and video recording.

Some embodiments of the present invention further comprise at least one focused object viewing device. PTZ cameras are typically used for this purpose. For each of the connected service user, the view presentation service center continuously track and locate the target object specified by the service user, and to estimation the motion parameters of the target object in the activity field. The position and motion data of the target object is then used to control the orientation of the PTZ camera such that the aim-point of the PTZ camera in the activity field follows the target object closely and at substantially the same velocity. The view presentation service center may further estimation the size of the target object in order to control the zoom of the PTZ camera to achieve a reference object presentation ratio in the final field of view. The view image of the PTZ camera is then processed by the view presentation service center to generate customer view image. Connected service users have the option to choose the individually focused target object view from the focused object viewing device or the extracted view from the field overview image as the final customer view image to be transmitted and displayed on user's view presentation device.

In some embodiments of the present invention, the focused object viewing device comprises a mobile platform to enable object surrounding tracking based target object following and view presentation. The PTZ camera is installed on a robot, vehicle or drone. Based on the target object's position and motion estimation data, the view presentation service center determines the reference position and motion of the mobile platform. The view presentation service center may further estimate the facing direction of the target object to determine a reference orientation of the mobile platform. After that, the view presentation service center controls the absolute motion of the mobile platform towards the reference position and at a motion substantially close to the determined reference motion. The view presentation service center further controls the orientation of the mobile platform towards the reference orientation. Next, the view presentation service center controls the relative orientation motion, including pan and tilt angular motions, of the PTZ camera such that the resulted aim-point motion in the activity field follows the target object closely and at substantially the same velocity.

In some embodiments of the present invention, the focused object viewing device comprises camera array that enable high-dimensional and dynamic video recording for the target object. The view presentation service center first obtains synchronized camera view images from video streams of the camera array. High-dimension dynamic object viewing model is then generated from the synchronized camera view images. Exemplary high-dimension dynamic object viewing models include but not limited to 360-degree object view, 3D/4D object view, etc. The view presentation service center next reconstructs a 2D object view image from the high-dimension dynamic object viewing model based on interactive view navigation data received from each connected user to produce final customer view image.

In some other embodiments of the present invention, the identified position of the target object is obtained from the position measurement of a positioning device. The identified size of the target object is next obtained as the evaluated size of a general object recognized as the target object at a position corresponding to the position measurement in a synchronized field overview view image. In this case, the synchronized field overview is associated to the position measurement and it is also used subsequently in the image data extraction for customer view image generation.

In some embodiments of the present invention, more than one automatic object tracking view presentation service systems are used to construct a distributed view presentation service system. Service users is able to switch object tracking view among all the available object tracking view presentations provided by each of the automatic object tracking view presentation service system to be able to view the target object from different view-angles and distances. Field overviewing devices from the distributed view presentation service system can further be used as camera arrays to construct high-dimension filed overviewing model to provide view navigation from continuously varying view-angle.

Illustrative embodiments of the present invention are directed to system and apparatus for providing focused view navigation inside a field overview for public service that enabling customized and focused view for each connected service user. Exemplary embodiments of the invention comprise at least one camera system; at least one displaying device; at least one communication network; and a computer based view presentation control service center. Additional features and advantages of the invention will be made apparent from the following detailed description of illustrative embodiments.

### BRIEF DESCRIPTION OF THE DRAWINGS

FIG. 1 is a schematic diagram of a view presentation service system that provides automatic object tracking and focused view presentation for public accessible services according to one or more embodiments;

FIG. 2 is a schematic diagram of a view presentation service system with illustrated networked communication device according to one or more embodiments;

FIG. 3 is a flowchart illustrating an automatic object tracking view presentation control method for public service according to one or more embodiments;

FIG. 4 is a flowchart illustrating a method for updating customer view frame data according to user inputs according to one or more embodiments;

FIG. 5 is a schematic diagram illustrating a telescopic mast device and support platform according to one or more embodiments;

FIG. 6 is a schematic diagram illustrating a pan-tilt unit device for orientation adjustment of the field overviewing device according to one or more embodiments;

FIG. 7 is a flowchart illustrating a method of automatically controlling the height and orientation parameters of the view presentation system by computer programs according to one or more embodiments;

FIG. 8 is a schematic diagram illustrating a view presentation service system that provides automatic object tracking and focused view presentation according to one or more embodiments;

FIG. 9 is a schematic diagram illustrating a method of determining the position and size of the customer view frame based on the identified position and size of the target object according to one or more embodiments;

FIG. 10 is a schematic diagram illustrating a method of determining the position and size of the customer view frame relatively based on the user's view navigation input according to one or more embodiments;

FIG. 11 is a schematic diagram illustrating a view presentation service system that provides automatic object tracking and focused view presentation using focused object viewing device according to one or more embodiments;

FIG. 12 is a flowchart illustrating a method for automatic view presentation control using focused object viewing device according to one or more embodiments;

FIG. 13 is a schematic diagram illustrating a view presentation service system using focused object viewing device on a mobile platform according to one or more embodiments;

FIG. 14 is a schematic diagram illustrating a view presentation service system using focused object viewing device with camera array according to one or more embodiments;

FIG. 15 is a flowchart illustrating a method for automatic view presentation control using focused object viewing device on a mobile platform according to one or more embodiments;

FIG. 16 is a flowchart illustrating a method for automatic view presentation control with camera array device according to one or more embodiments;

FIG. 17 is a flowchart illustrating a method for determining the identified position and size of the target object according to one or more embodiments;

### DETAILED DESCRIPTION OF THE INVENTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

The present invention discloses system and methods for providing smart object focusing and connected view presentations for public accessible service such that each connected service user can have an individually specified target object automatically tracked and continuously presented on user's view presentation devices. This invented auto-focusing view presentation system has a telescopic mast and platform that enables it to be deployed to any sport and performance activity environments. The platform can be a mobile platform and even automatically move like a robot to adjust its location with respect to target objects to achieve a best view presentation quality. The invented system is truly public sharing system that is capable to provide smart object following view presentation to all the connected users that have their individually target object specified to be tracked in view. None of the uses are required the carry such system but to have a view presentation device, like smartphone and table computer, to wirelessly connected to the invented system, or to connect remotely through Internet.

The invented view presentation system has variable configuration capability to further provide focused object tracking view using focused object viewing devices that have camera capturing the view solely on the target object by aligning their aim-point of the camera with the position and motion of the target object. Such focused object viewing devices can be equipped with mobile tracking platform, like robots, vehicles or drones, to surround the target object in motion. Such focused object viewing devices can further provide high-dimension dynamic view presentation using camera arrays.

The invented automatic object tracking view presentation system integrates telescopic mast device and support platform, field overviewing device, focused object viewing device, computerized view presentation service center, as well as networked communication device and power supply device. It is able to provide automatic object viewing applications including: general object locating; target object specification from user's view presentation devices; automatic object following and view focusing control; view presentation video playing and recording; etc.

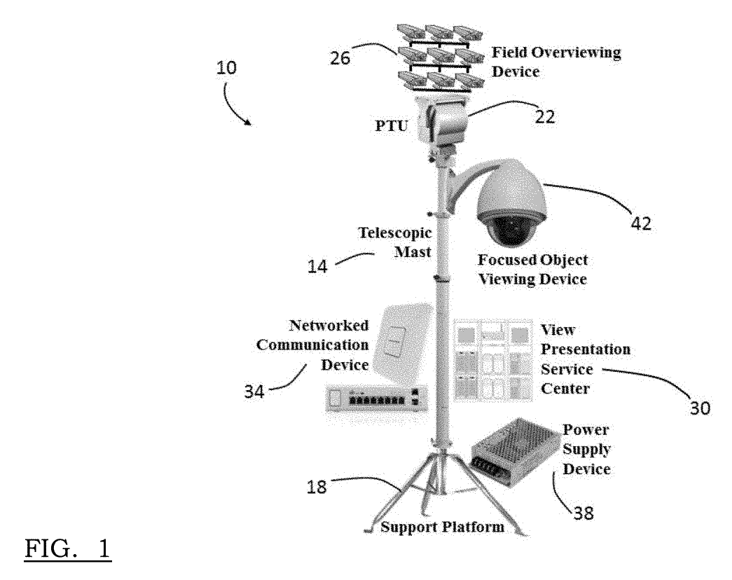

With reference to FIG. 1, a view presentation service system that provides automatic object tracking and focused view presentation for public accessible service is illustrated in accordance with one or more embodiments and is generally referenced by numeral 10. The service system 10 comprises fundamentally a telescopic mast device 14, support platform 18, and a PTU 22. The service system 10 further comprises a field overviewing device 26 for providing high resolution field overview image and video stream over a sport activity field and a view presentation service center 30 for processing the field overview image to support target object specification, object positioning, object tracking view presentation, etc.

The service system 10 also comprises networked communication device 34 for providing data communications among subsystems and connecting to service users, and a power supply device 38 for supplying electric power. The service system 10 can further integrate focused object viewing device 42 to achieve high quality and dynamic object view presentation over individual target object.

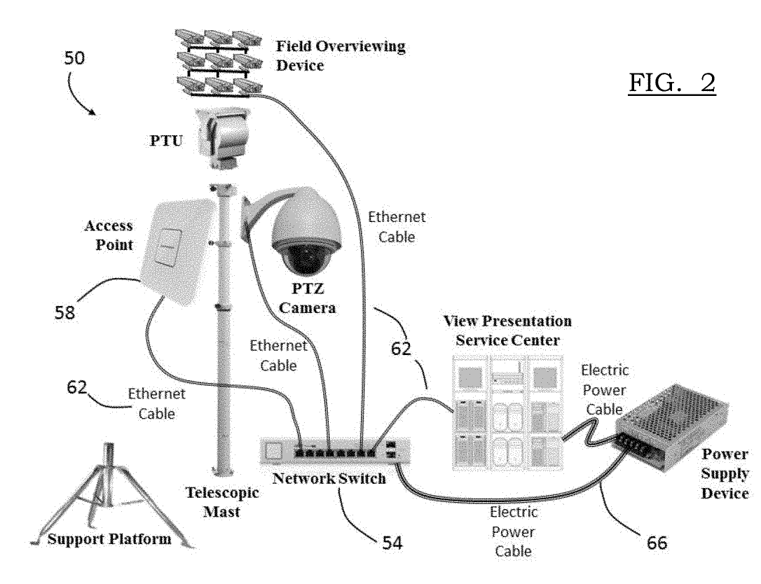

With reference to FIG. 2, a view presentation service system with illustrated networked communication device is illustrated in accordance with one or more embodiments and is generally referenced by numeral 50. In this embodiment of the view presentation system 10, the networked communication device 34 comprises a network switch 54 that provides data communication from the field overviewing device 26, the focused object viewing device 42 to the view presentation service center 30. The networked communication device 34 further comprises at least one WiFi access point 58 to provide wireless communication access to this view presentation system 10 for on-site service users. The networked communication device 34 can also connect to Internet through wired or wireless communication means to support view presentation service and video recording service for users that access the system from remote sites. The power supply device 38 can connect to electric grid to provide electric power to system 10. In outdoor application situations, battery and generator based power supply system are typically used for the power supply device 38. The power supply device 38 powers the view presentation service center 30 and the network switch device 54 using electric power cables 66. When electro-mechanical support platform 18, electrical actuated telescopic mast 14 and electro-mechanical PTU 22 are used in this system 10, power supply cables 66 are typically used to connect them to the power supply device 38. The rest of the system 10, including the field overviewing device 26, the focused object viewing device 42 and the Wi-Fi access point 58 are typically powered through Ethernet cables by the network switch 54. In some other embodiments of system 10, these subsystems can also be powered separately using power cables 66 and connected either directly or indirectly to the power supply device 38.

The field overviewing device 26 comprises at least one camera device for capturing field overview image and for transforming the camera view image in video stream to the view presentation service center 30. Due to data size and view coverage limitation, each of the camera view image may only cover a certain sub-area of an activity field. When the activity field is quite large, single camera is insufficient for achieving high resolution view coverage over the whole activity field. In this case, multiple camera systems, like camera arrays, are usually installed to achieve full field coverage by proper arrangement and coordination of all the camera view coverages. The field overview image constructed from a plurality of camera view images is able to provide sufficient view coverage over the activity field while still retaining adequately high image resolution to reveal detailed object information. Other types of camera devices, like pinhole cameras, can have nearly full view coverage over an activity field. Since their view frames have strong distortion, their view image has to be de-wrapped using 3D transformation to generate a final field overview image.

When a plural of camera view images is used, image combination method is needed to produce the field overview image. Exemplary image combination methods include but not limited to image transformation method, image stitching method, and image combination method with predefined image stitching scheme and/or image transformation scheme. The generated field overview image has a 2-dimentional field overview image coordinate system W-H defined for it such that each pixel point on the field overview image has a unique image position coordinate (wₚ, hₚ) to identity its location.

A public service user connects to the view presentation system 10 using a view presentation device. Exemplary embodiments of the view presentation device are smartphone, tablet computer, laptop/desktop computer, TV set, stadium large screen, etc. After receiving the image data of the generated customer view image, the view presentation device can either display the customer view image video on its screen or record the customer view image into video records. Some exemplary embodiments of the displaying device have input interface, touch screen or mouse, to take user's view navigation commands and to communicate customer view navigation data with the view presentation service center 30. Some other embodiments of the displaying device comprise distributed system that comprises a set of devices that work on user interface, displaying, data and operation processing individually, or even through a computer network.

In some embodiments, the system 10 comprises additionally object positioning and tracking system that provides object positioning measurement in an activity field. Exemplary embodiments of such positioning and tracking system may further comprises position measurement device attached to each of the target objects in order to supply position measurement data, and even motion measurement data, to the view presentation service center 30. Wi-Fi signal, radio frequency signal, infrared or laser signals are typically used by the position measurement devices to detect object's position. Some other exemplary embodiment of such positioning device uses global positioning device, like GPS, and Inertial Measurement Unit to provide position measurement. In some cases, object size and orientations can be further derived from the measurement data plus the object's image data identified from the field overview image.

The view presentation service center 30 is a computer device that comprises memory and at least one processor. The view presentation service center 30 is designed to provide a bunch of system operation functions comprising: service user input/output control and communications; field overview image generation; general object location and motion; target object recognition; customer view frame control and customer view image generation, etc. The advanced system functionalities of the view presentation service center 30 further comprises telescopic mast elevation control and PTU orientation control, mobile support platform actuation control and automatic motion control, mobile platform position and motion control for the focused object viewing device, high-dimension dynamic view presentation control for the focused object viewing device using camera arrays, etc.

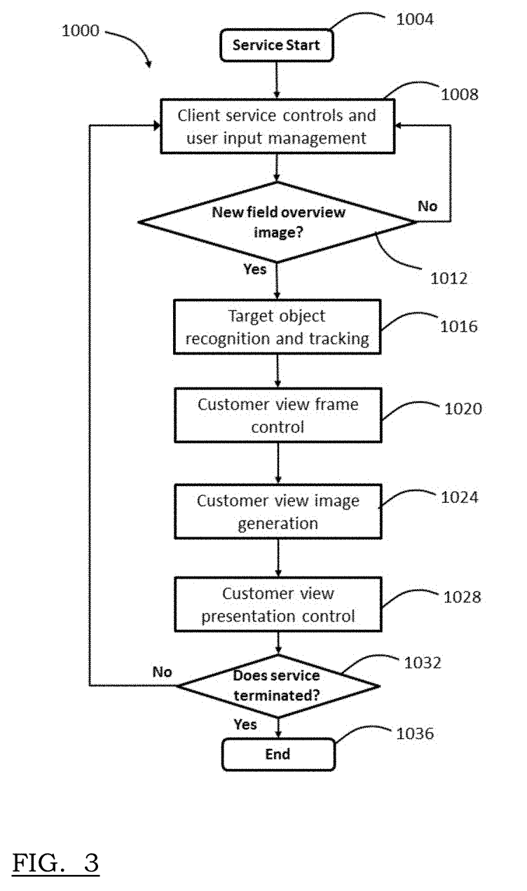

With reference to FIG. 3, an automatic object tracking view presentation control method for public service is illustrated according to one or more embodiments and is generally referenced by numeral 1000. This method realizes the fundamental control functions of the view presentation service center 30. After service starts at step 1004, this method first carries out client service control and user input management at step 1008. The client service control establishes service connection with new user once service request is received and it manages user account information, user profile data, and all other user oriented service system parameters. For each connected user, a customer view frame is defined to specify where inside a field overview image the user want to have focused view presentation. For connected users, the user input management executes the control and operation commands received to finish control tasks like target object specification and cancellation, customer view frame relative adjustments on shape, position and size, etc. A connected user will be removed from service once disconnection request is received from his/her displaying device.

Next, the method 1000 checks on if there is a newly updated field overview image received from the field overviewing device 26 at step 1012. If not, the method 1000 will continue waiting for field overview image update while watching on client service control and user input management at step 1008. Once a field overview image update condition is satisfied at step 1012, the method 1000 next starts on generating a new high resolution field overview image from the available one or a plural of camera view images.

In the generated field overview image, general objects are spotted and their position and size are evaluated inside the field overview image at step 1016. In this step, image processing and object recognition methods are typically used to scan the field overview image and to identify all candidate objects that are presented in the view covered activity field. In a preferred embodiment of the method 1000, the position and size of the spotted general objects are represented by a rectangle envelop that encloses the image of the general object tightly in the field overview image. The general object envelop has its center position (w_{g}, h_{g}) and its width W_{g} and height H_{g} and the parameter set for the general object envelop is represented as (w_{g}, h_{g}, W_{g}, H_{g}) and all the parameters are defined in the field overview image coordinate system.

After finishing general object location, for each connected user that has a target object specified, advanced object recognition methods are used to further recognize among all general objects the target object to be tracked in view. Exemplary methods for advanced object recognition include but not limited to: feature matching method, optical flow method, template matching method, motion validation method, neural network method and key point matching method, etc. Once a general object is recognized as the target object, its position and size inside the field overview are rendered as the identified position and size for the target object. Digital signal filter may be used in the rendering process. In a preferred embodiment of the method 1000, the position and size of the target object is also identified by a rectangle envelop with parameters (wₒ, hₒ, Wₜ, Hₜ) and the target object envelop inherit the values of the general object envelop from a general object that has been recognized as the target object, such that (wₒ, hₒ, Wₜ, Hₜ)=(w_{g}, h_{g}, W_{g}, H₉)ᵢ, where the subscript i denote the envelop parameter set for the i-th general object. In the following description, the target object envelop is frequently used to represent the identified position and size of the target object inside the field overview image.

In some embodiments of the step 1016, the general object scanning and spotting process may only be carried out in a sub-region inside the field overview image. And the sub-region used is sufficiently large and it surrounds a previously known position of the target object.

In some embodiments of the method 1000, the object position is measured separately by a positioning device. In this case, the identified position of a target object is obtained by transforming the position measurement from a field coordinate system to the field overview image coordinate system. The identified size of the target object is obtained as the size of a general object recognized as the target object at a position corresponding to the position measurement in a field overview image that is associated to the position measurement. In this case, the field overview image that is associated to the position measurement is also used subsequently to extract the image data for generating the customer view image. The association between the object position measurement and the field overview image is established either through time synchronization or through frame sequence synchronization.

For a connected user that has not have his/her target object specified, the customer view frame is determined purely by user's view navigation input such that a customer view image is generated from the field overview image data inside the customer view frame accordingly as an overview image into the activity field. In this case, all the spotted general objects that are covered in view by an overview image will be highlighted, e.g. by displaying the object envelops, while the overview image is displayed on the user's displaying device. Any of the general objects that are highlighted in the overview image can be selected as the target object for each of the connected users. In an exemplary embodiment, a service user specifies a general object as his/her target object of interest by tapping inside the rectangle envelop surrounding the general object on the screen of the user's displaying device. A target object is specified with its initial identified position and size rendered as the evaluated position and size of the general object selected.

In an exemplary illustration, a user's view presentation device is represented by a cellphone. And the user's input device is represented by hand fingers. In some other embodiments, the user's input device can be a computer mouse, a remote controller, a keyboard, and even a (vision, laser, radar, sonar, or infrared) sensor based gesture inputs.

On the touch screen of the cellphone, a figure slide left motion is interpreted as pan left motion command to the customer view frame. Similarly, a figure slide right commands pan right motion, a finger slide up commands tilt up motion and a finger slide down commands tilt down motion. A finger slide in an arbitrary angle can always be decomposed into the four basic finger slide based translational view navigation motions described before. For connected users that have no target object specified, such translational view navigation motions are directly interpreted as the corresponding pan and tilt motions of the customer view frame inside the field overview image, where an overview image is generated out of the customer view frame subsequently. For connected users that have their target object specified, such translational view navigation motions control the relative offset of the customer view frame to the identified center of the target object. The values of the offset parameters (e_{w}, eₕ) get updated additively after new translational motion command is received from the user's displaying device.

When detecting two finger touch on screen, the pixel point of the customer view image corresponds to the geometric center point between the touch points of the two finger on the screen is regarded as the motion center. The two finger stretch out motion is then interpreted as zoom-in motion with respect to the motion center, while two finger close motion is interpreted as zoom-out motion of the customer view frame inside the field overview image frame. The two figure touch rotation motion is then directly interpreted as the customer view frame's rotation motion at a corresponding rotation angle in the same rotation direction with respect to the motion center. For connected users that have no target object specified, such zoom and rotation motions are carried out absolutely inside the field overview image to adjust the size and view angle of the overview image generated. For connected users that have their target object specified, such zoom and rotation motion are carried out relatively with respect to the target object envelop to adjust the stretching ratio and relative rotation angle of the customer view frame to change the size and the posture angle of the target object presented in the generated customer view image. In such a similar manner, more complicated view navigation inputs can be generated to produce complex customer view navigation motions in order to view different areas inside the field overview image or to achieve different object tracking view patterns.

For each connected service user, the defined customer view frame is managed at step 1020. The customer view frame is a closed geometric region inside the image area of the field overview image. A rectangle shaped region is typically used to define the customer view frame with position and size parameter defined as (w_{f}, h_{f}, Wᵥ, Hᵥ). Some other embodiments of the customer view frame include quadrilateral shapes, like trapezoid that is used to enable perspective transformation effects.

The position and size of the customer view frame are determined based on view navigation data comprising user's view navigation inputs and, most importantly, the automatically tracked target object's position and size. The determination is first based on the identified position and size of the target object that has been specified by each connected user. The position and size of the customer view frame is secondly determined relatively based on user's view navigation inputs. Exemplary embodiments of the position and size relationship between the customer view frame and those of the target object include but not limited to centering, center aligning, offset, rotation, expanding, shrinking, aspect ratio adjustment, and shape variations. By identifying the position and size of a target object, the position and size of the customer view frame gets updated accordingly after a new field overview image is generated or loaded such that the image of the target object is sufficiently covered and centered inside the field overview image area that is enclosed by the customer view frame. A connected service user may build up multiple connected view presentation services within one application and thus the user can have more than one target object tracked and presented in delivered view presentations. In some embodiment of the method 1000, the target object is a group object that comprises multiple general objects. In this case, the target object envelop is determined by a minimal rectangle region that enclose all the general object envelops inside the field overview image.

For each customer view frame, after initialized with default relative position and sizing parameters, its appearance can be adjusted by user's view navigation inputs received from the user's view presentation device. In an exemplary embodiment, user's view navigation input on a touch screen may comprise move-up, move-down, move-left, move-right, open, close, and rotation to a certain angle and in a certain direction (clockwise or counter-clockwise) with respect to a rotation center. Such view navigation inputs from the view navigation device are communicated to the view presentation service center 30 and they are executed to adjust the relative position and sizing parameters of the customer view frame with respect to the identified position and size of the target object. The corresponding adjustments comprise offset adjustment, stretching ratio adjustment, rotation angle adjustment, and deflection ratio adjustment, with respect to the target object envelop.

The image data inside the customer view frame are extracted from the field overview image and are processed to generate the customer view image at step 1024. A raw customer view image is first produced. Based on user's displaying settings and system configurations, the raw customer image can be further processed to finalize the customer view image through resize, 2D and/or 3D transformation, image decoration, image processing, etc.

For each connected service user, the customer view presentation control is executed at step 1028. The final generated customer view image or the overview image is transmitted and presented on the user's displaying device. Data compression method and socket communication method are typically used to send the image data to the user's displaying device. In addition, the generated customer view image can be recorded into view presentation video files.

The service method 1000 continues from step 1032 to step 1008 to repeat the service processing steps if the connected view navigation service is not terminated. Otherwise, it stops at step 1036. The service method illustrated in FIG. 3 only serves to present a minimal level of processing steps that the invented automatic object tracking view presentation service system comprises. In applications, service functions inside a realization of the invented view presentation service system 10 may take different sequences and the executions of certain functions can be independent or in parallel to the rest of function executions.

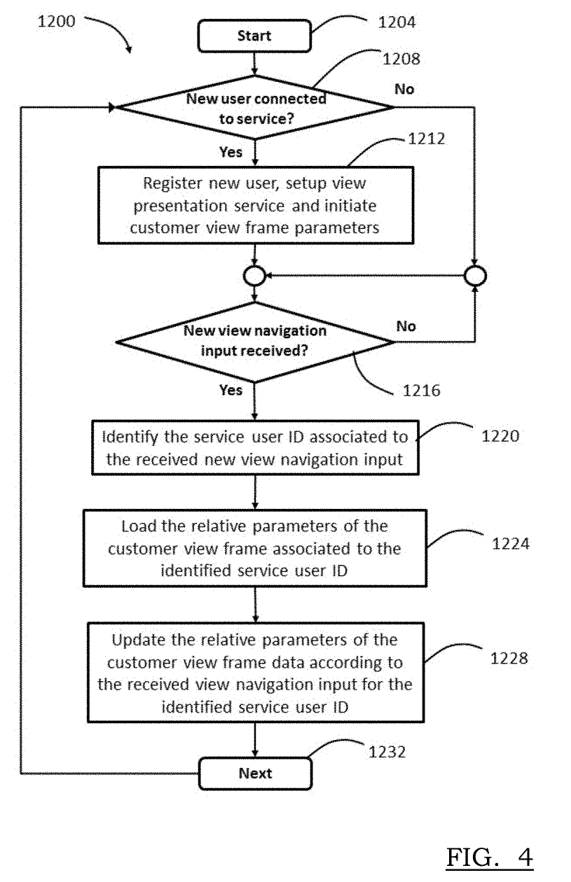

With reference to FIG. 4, a method for updating customer view frame data according to user inputs is illustrated according to one or more embodiments and is generally referenced by numeral 1200. After the process starts at step 1204, new user connection request is checked at step 1208. When new user connection request is received, the method 1200 will setup view service for the new user and initiate customer view frame in the field overview image and other necessary system service parameters and configurations at step 1212. The method 1200 next checks for each connected service user if new view navigation command is received from connected user's displaying device. The view navigation command contains controls to adjust the relative position and size of the customer view frame to the field overview frame or to the target object envelop. Once received, step 1220 is carried out to first identify the service user ID that associates to the received new view navigation input. The relative position and sizing parameters of the customer view frame that belong to the identified service user are then loaded at step 1224. The offset parameters and the stretching parameters are updated respectively according to the type of view navigation command received. For example, a figure slide left motion will add more negative offset to e_{w}; a finger slide up will add more positive offset to eₕ; a two finger stretch-out action will result in increasing the value of stretching parameters s_{w} and sₕ; a two-figure touch rotation motion will result in changing the relative rotation angle ϕ accordingly. After that, the method 1200 will continue to step 1232 and then wait for future service connection request and view navigation input from step 1208.

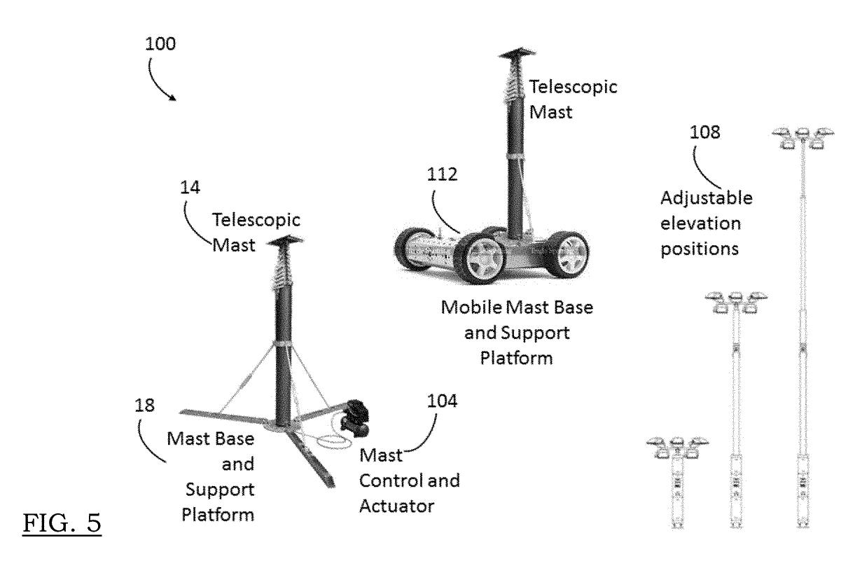

With reference to FIG. 5, a telescopic mast device and support platform is illustrated in accordance with one or more embodiments and is generally referenced by numeral 100. The telescopic mast system 14 and platform 18 provide convenient deployment solution to the invented system 10. The telescopic mast system is compact when not in use such that it is easy to be put in cars when transporting to destinations. The telescopic mast has adjustable elevation position 108 such that it can be elevated to achieve a variably high view point in deployment in order to provide best field overview and object positioning and tracking results. The height of the telescopic mast device can either be adjusted manually, or it comprises electro-mechanic mast control and actuator unit 104 to control the height through user inputs or by computer programs. The telescopic mast system comprises a mast base system 18 to provide support and stability to the whole system. The mast base system can be a mobile platform 112 and such mobile platform can be a robotic platform to provide automatic and controllable object surrounding view presentation to closely follow moving target object in sport events.

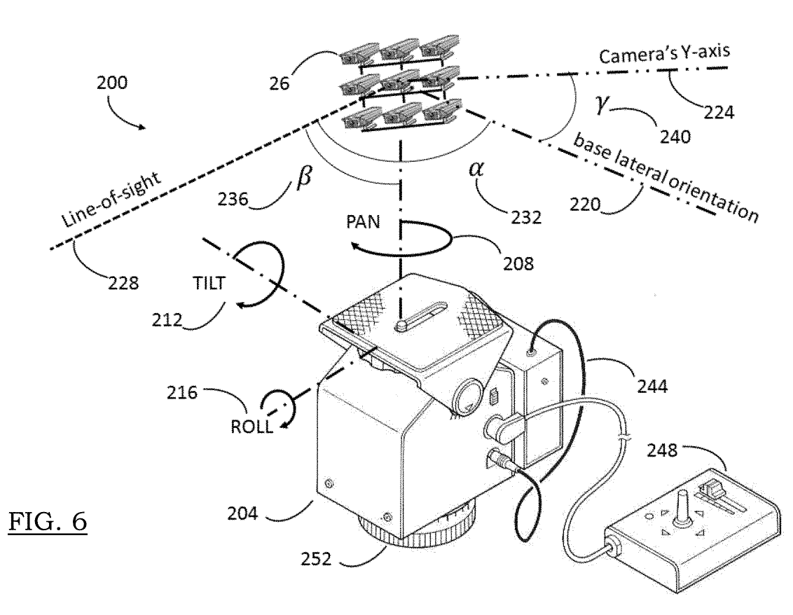

With reference to FIG. 6, a PTU device for orientation adjustment of the field overviewing device is illustrated in accordance with one or more embodiments and is generally referenced by numeral 200. In some embodiment of this invention, a PTU 204 has connection 252 to be installed at the head of the telescopic mast to provide pan angle, tilt angle and rotation angle adjustment capabilities that changes the orientation of the filed overviewing device 26 with respect to an activity field. The PTU 204 can first pan 208 with respect to the vertical axis and generate a relative pan angle α 232 with respect to the base lateral orientation 220. The PTU 204 can next tilt 212 with respect to the base lateral orientation 220 and to generate a relative tilt angle β 236 with respect to the vertical axis. The mounting mechanism of the filed overviewing device 26 can further rotate 216 with respect to the line-of-sight 228 to adjust the camera's Y-axis 224 relatively with the activity field. This results in a rotation angle y 240 between the camera's Y-axis and the base lateral orientation of the PTU 204. The PTU 200 can be a mechanical device with manual pan, tilt, and rotation angle adjustment mechanism to change the orientation angle for the field overviewing device 26. The PTU 204 can further be an electro-mechanical device with electrical power supply 244 such that the pan, tilt and rotation angles can be adjusted using a remote control unit 248 or it can be controlled by computer programs automatically.

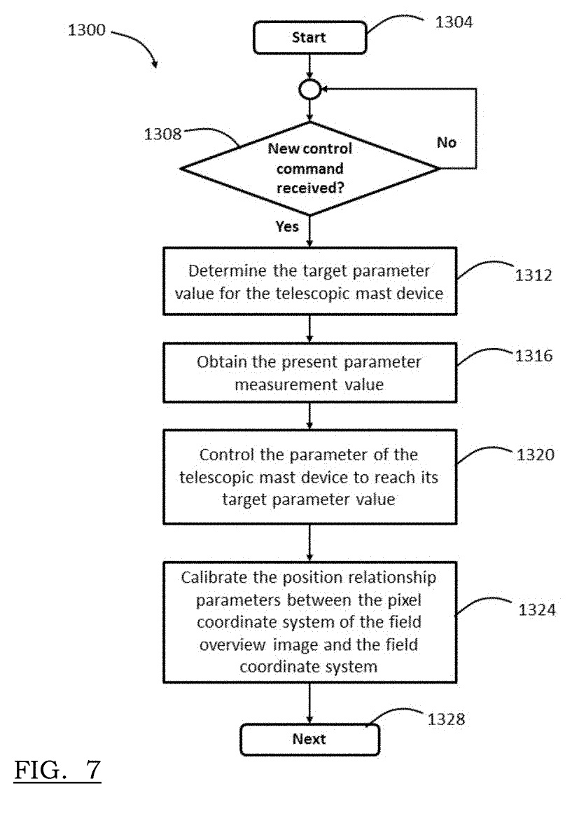

With reference to FIG. 7, a method for automatically controlling the height and orientation parameters of the view presentation system by computer programs is illustrated according to one or more embodiments and is generally referenced by numeral 1300. After the process starts at step 1304, method 1300 first checks on if new control commend is received either from remote control device or from computer programs in the view presentation service center 30 at step 1308. The control command contains control operation request with respect to parameters of the telescopic mast device including the elevation of the telescopic mast, the pan angle of the PTU, the tilt angle of the PTU, and the rotation angle of the field overviewing device, etc. When new control command is received at step 1308, the view presentation service center 30 first decodes the requests and it determines the target parameter values for the telescopic mast device at step 1312. The present height and orientation parameter states are next obtained through measurement at step 1316 to support the actuation control adjustment. The control operation request can also be commanded in a relative format with differential angular and translational motions that can be executed directly. At step 1320, the view presentation service center 30 actuates the corresponding electro-mechanical actuators for the telescopic mast height control and the pan-tilt-rotation control of the PTU to reach their target positions with target parameter value read out from their measurement. After every height and orientation adjustment, it is necessary to carry out position relationship calibration at step 1324 when object positioning in the activity field in needed, especially when the focused object viewing device 42 is used in the view presentation service. At this step, the position transformation relationship between the pixel coordinate system of the field overview image and the field coordinate system is updated with respect to the new orientation of the field overviewing device 26 that is resulted by adjusting any of the height of the telescopic mast and/or the PTU orientation. The process 1300 ends at step 1328.

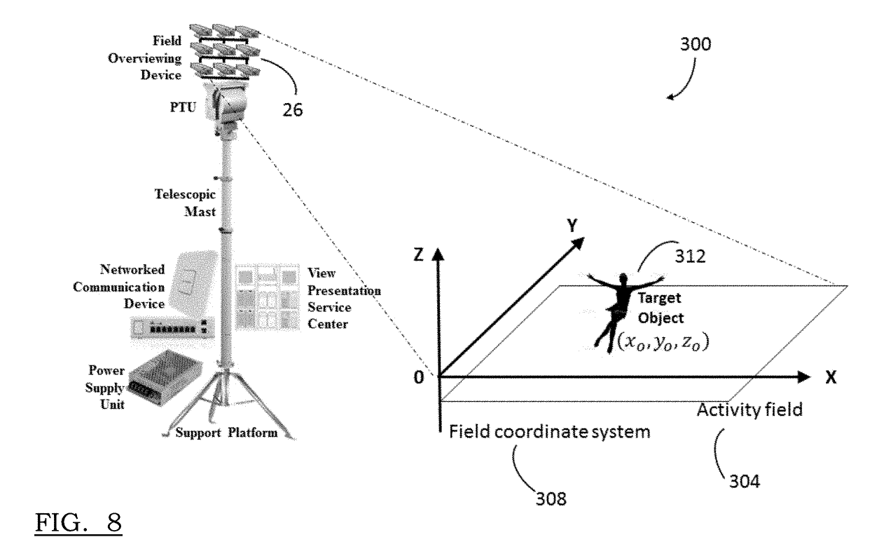

With reference to FIG. 8, a schematic diagram of a view presentation service system that provides automatic object tracking and focused view presentation is illustrated according to one or more embodiments and is generally referenced by numeral 300. In the illustration, an activity field 304 is represented by a figure skating ice rink that is covered in the camera view of field overviewing device 26. A field coordinate system X-Y-Z 308 is defined for this activity field 304 to support position measurement in the object positioning and tracking system such that each position inside the activity field 304 has a unique position coordinate (x, y, z). An object 312 in the activity field 304 is illustrated as a skater that has an object position in the field coordinate system 308 as (xₒ, yₒ, zₒ). An object that is spotted and presented in the field overview images is a general object. Any general object 22 can be specified by a connected service user as his/her target object that will be tracked automatically and presented continuously in the view presentation displayed to the service user thereafter.

The obtained object position coordinate (xₒ, yₒ, zₒ) in the field coordinate system 308 can be transformed to a unique pixel position (wₚ, hₚ) in the field overview image coordinate system. The obtained object sizing information can also be transform from its data in the filed coordinate system 308 to the pixel coordinate system of the field overview image, for example, in a data structure defined for a rectangle shape. The final object positioning and sizing information is reported to the view presentation service center 30.

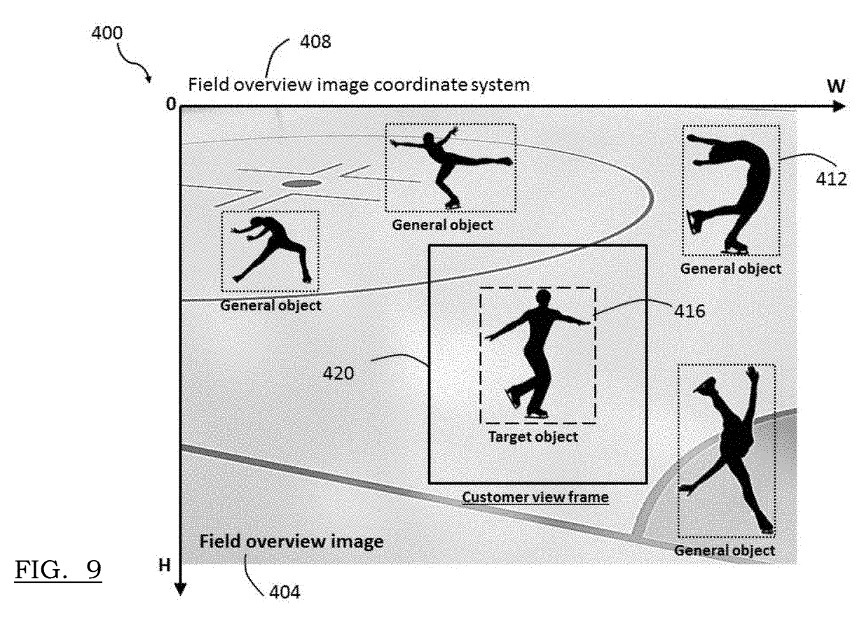

With reference to FIG. 9, a schematic diagram of the method for determining the position and size of the customer view frame based on the identified position and size of the target object is illustrated according to one or more embodiments and is generally referenced by numeral 400. An image that has its view over an area of an ice rink is used as an exemplary embodiment of the field overview image 404. A field overview image coordinate system W-H 408 is defined for the 2-dimentional field overview image such that each pixel point on this field overview image has a unique coordinate position (wₚ, hₚ). After generating the field overview image 404, the view presentation control method 1000 first scans the image to spot and locate the general objects. In this schematic diagram, the general objects are illustrated as skaters on the ice rink. Each of the general objects, after being spotted and located with evaluated position and size, are enclosed by its general object envelop. The general object envelops are illustrated by dotted line rectangles 412. Given a i-th general object's envelop parameter (w_{g}, h_{g}, W_{g}, H _{g})ᵢ, the center position of the i-th general object is evaluated as (w_{g}, h_{g}). The size of the general object is evaluated as (W_{g}, H_{g}), where W_{g} is the object width and H_{g} is the object height in the field overview image coordinate system, respectively.

The view presentation control method 1000 next scan through the general objects spotted to recognize the target object for each of the connected users. The target object 416, once recognized, inherit the object envelop from its original general object to identify its position and size. Based on the identified position and size of the target object, the customer view frame 420 is then determined as another rectangle shaped region with its center position determined relatively offset to the center position of the target object envelop and its width and height determined relatively with respect to the width and height of the target object envelop at certain stretching ratios. Similarly to the definition of the identified position and size for the target object, in a preferred embodiment of the presentation control method 1000, the position of the customer view frame is defined as the center position of the rectangle shaped region and the size of the customer view frame is defined by the width and height of the rectangle shaped region. In some embodiment of the control method 1000, the position of the target object is defined at a characteristic point on the image of the recognized target object instead of the center point of the target object envelop. The determined position of the customer view frame can align to the characteristic point position rather than the center point of the target object envelop in a center-aligning relationship method.

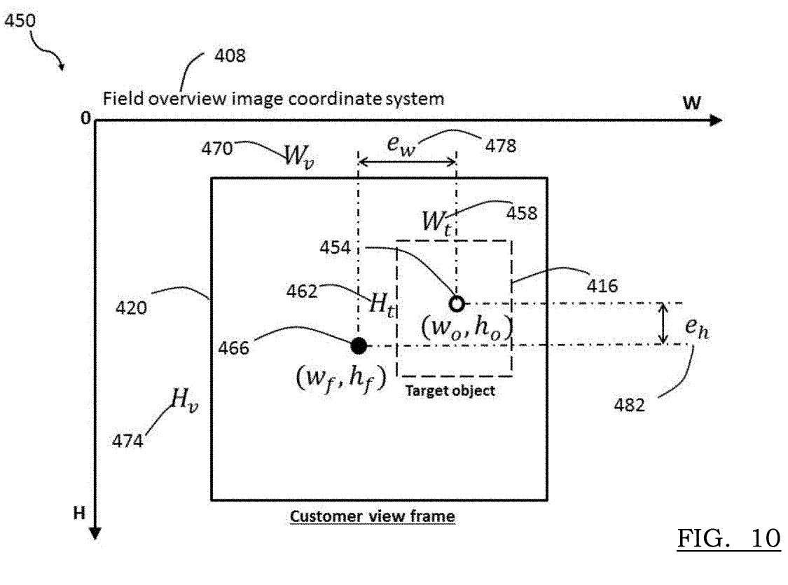

With reference to FIG. 10, a schematic diagram of the method for determining the position and size of the customer view frame relatively based on the user's view navigation inputs is illustrated according to one or more embodiments. In an exemplary embodiment, the identified position of the target object 416 is represented by the geometric center of its rectangle envelop 454 that has a coordinate (wₒ, hₒ) 454 in the field overview image coordinate system 408. In some other embodiment, the identified position of the target object 416 is determined by a characteristic body point of the recognized target object. The target object envelop has a width of Wₜ 458 and a height of Hₜ462. In a preferred embodiment of the method 450, the customer view frame is defined as a rectangle in the field overview image coordinate system 408 with a geometric center position at (w_{f}, h_{f}) 466, a width Wᵥ 470 and a height Hᵥ 474. The center position offset (e_{w}, eₕ) defines the relative position difference between the center of the target object and the center of the customer view frame, where e_{w} 478 defines the horizontal position difference and eₕ 482 defines the vertical position difference. When the offset parameters are zeros, the customer view frame is centered at the target object's position. When a characteristic point on the image of the target object is used as the identified position of the target object, centering aligning relationship is used to set the center point of the customer view frame at the characteristic point.

The stretching ratio (s_{w}, sₕ) defines the relative sizing of the customer view frame to the target object envelop, where s_{w}=Wᵥ/Wₜ and sₕ=Hᵥ/Hₜ. When s_{w} and sₕ are larger than 1, the customer view frame enclose the target object's envelop. The larger the stretching ratio parameters, the larger the size of the customer view frame is relatively to the size of the target object. On the other hand, when certain details on the target object is to be discovered, the stretching ratio parameters take values less than 1 in order to have the customer view frame zoom-in a certain sub-area inside the image of the target object. The customer view frame has a relative rotation angle ϕ to represent how much it is relatively rotated with respect to the right direction of the target object envelop. The customer view frame also has deflection ratio parameter defined to tell how it deflects from a rectangle shape when a quadrilateral shape is used. This is a useful feature when perspective transformation is needed in the final customer view image construction.

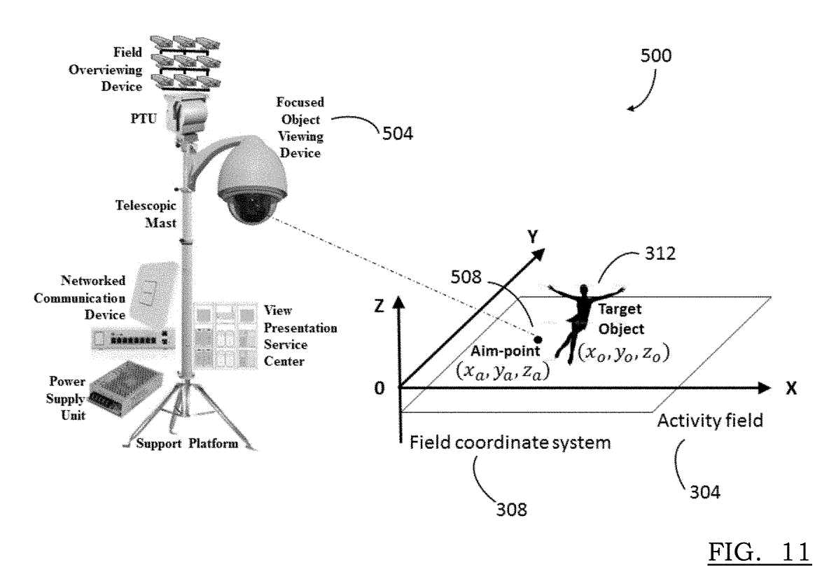

With reference to FIG. 11, a schematic diagram of a view presentation service system that provides automatic object tracking and focused view presentation using focused object viewing device is illustrated according to one or more embodiments and is generally referenced by numeral 500. The invented system 10 further integrate focused object viewing device 42 to achieve high quality and dynamic object view presentation over individual target object. In a primarily exemplary embodiment, the focused object viewing device is a Pan-Tilt-Zoom (PTZ) camera device 504 attached to the telescopic mast platform 14 that can be controlled by the view presentation service center 30 to automatically adjust the orientation of its lens such that its aim-point resides closely at the target object's position in the activity ground. Its zooming ratio can also be controlled to automatically adjust to a target object presentation ratio in the final view image.

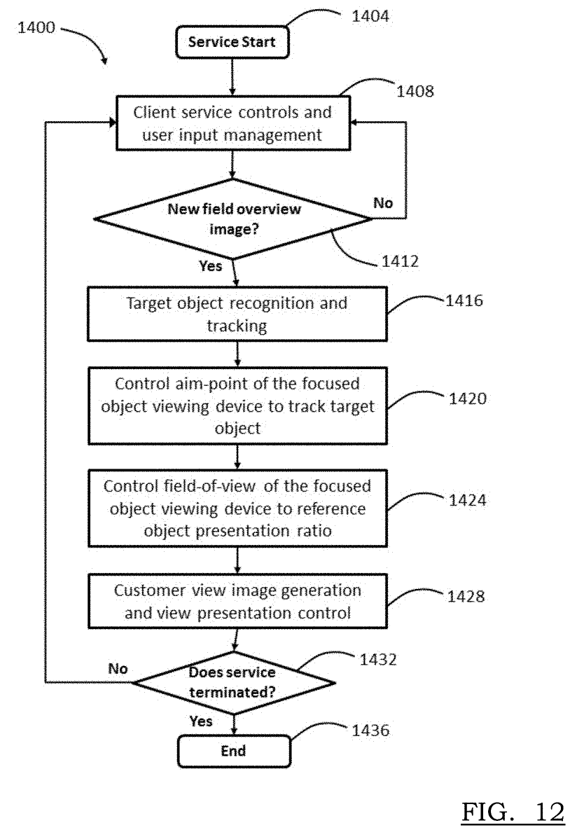

With reference to FIG. 12, a method for automatic view presentation control using focused object viewing device is illustrated according to one or more embodiments and is generally referenced by numeral 1400. This method realizes an advanced control functions of the view presentation service center 30. After service starts at step 1404, this method first carries out client service control and user input management at step 1408. The method 1400 next checks on if there is a newly updated field overview image received from the field overviewing device 26 at step 1412. If not, the method 1400 will continue waiting for field overview image update while watching on client service control and user input management at step 1408. Once a field overview image update condition is satisfied at step 1412, the method 1400 next starts on generating a new high resolution field overview image from the available one or a plural of camera view images. In the generated field overview image, general objects are spotted and their position and size are evaluated inside the field overview image at step 1416. This step is the same as step 1016 in the method 1000 illustrated in FIG. 3. The position and motion in the field coordinate system 308 for each of the target objects are also determined in this step.

For each of the connected service user, the view presentation service center continuously track and locate the target object specified by the service user, and to estimation the motion parameters of the target object in the activity field. The position and motion data of the target object is then used to control the orientation of the PTZ camera such that the aim-point 508 of the PTZ camera in the activity field follows the target object closely and at substantially the same velocity at step 1420. The view presentation service center may further estimation the size of the target object in order to control the zoom of the PTZ camera to achieve a reference object presentation ratio in the final field of view at step 1424. The view image of the PTZ camera is then processed by the view presentation service center to generate customer view image at step 1428. Connected service users have the option to choose the individually focused target object view from the focused object viewing device or the extracted view from the field overview image as the final customer view image to be transmitted and displayed on user's view presentation device.

The service method 1400 continues from step 1432 to step 1408 to repeat the service processing steps if the connected view navigation service is not terminated. Otherwise, it stops at step 1436. The service method illustrated in FIG. 12 only serves to present a minimal level of processing steps that the invented automatic object tracking view presentation service system comprises. In applications, service functions inside a realization of the invented view presentation service system 10 may take different sequences and the executions of certain functions can be independent or in parallel to the rest of function executions.

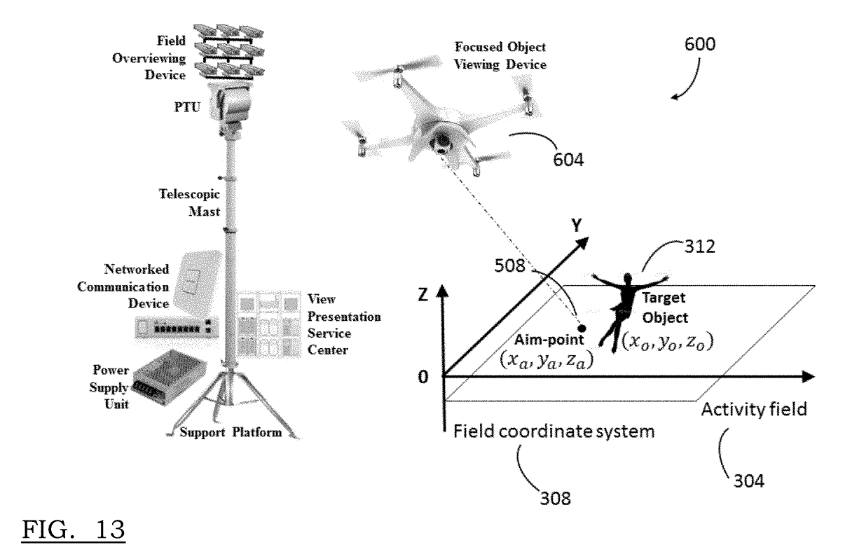

With reference to FIG. 13, a schematic diagram of a view presentation service system using focused object viewing device on a mobile platform is illustrated according to one or more embodiments and is generally referenced by numeral 600. The PTZ camera can further be installed on a mobile platform 604, like robot, vehicle or drone, to achieve enhanced object surrounding video tracking presentation. In this case, the position and motion of the mobile platform is controlled by the view presentation service center 30 to reach an optimal relative position and relative orientation with respect to the target object, as well as at an optimal relative motion.

Based on the target object's position and motion estimation data, the view presentation service center determines the reference position and motion of the mobile platform. The view presentation service center may further estimate the facing direction of the target object to determine a reference orientation of the mobile platform. After that, the view presentation service center controls the absolute motion of the mobile platform towards the reference position and at a motion substantially close to the determined reference motion. The view presentation service center further controls the orientation of the mobile platform towards the reference orientation. Next, the view presentation service center controls the relative orientation motion, including pan and tilt angular motions, of the PTZ camera such that the resulted aim-point motion in the activity field follows the target object closely and at substantially the same velocity.

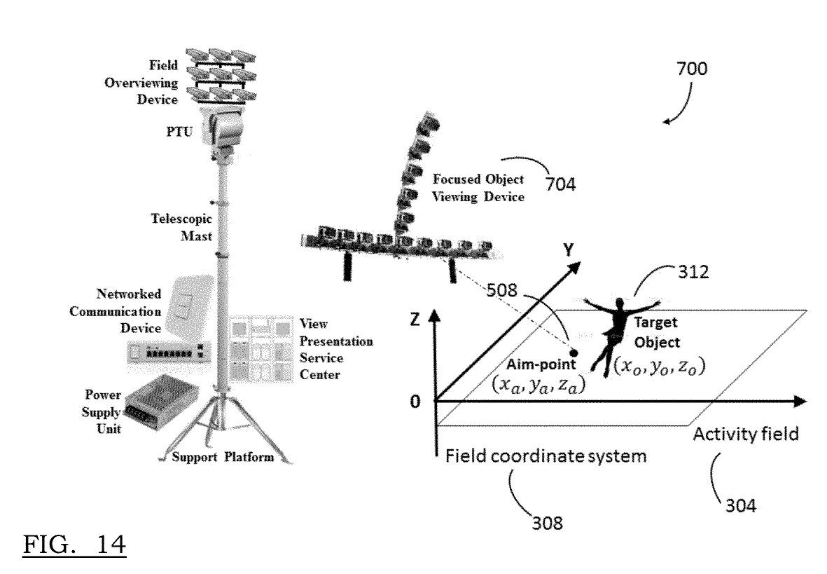

With reference to FIG. 14, a schematic diagram of a view presentation service system using focused object viewing device with camera array is illustrated according to one or more embodiments and is generally referenced by numeral 700. In some embodiments of the present invention, the focused object viewing device comprises camera array 704 that enable high-dimensional and dynamic video recording for the target object. The view presentation service center first obtains synchronized camera view images from video streams of the camera array. High-dimension dynamic object viewing model is then generated from the synchronized camera view images. Exemplary high-dimension dynamic object viewing models include but not limited to 360-degree object view, 3D/4D object view, etc. The view presentation service center next reconstructs a 2D object view image from the high-dimension dynamic object viewing model based on interactive view navigation data received from each connected user to produce final customer view image.

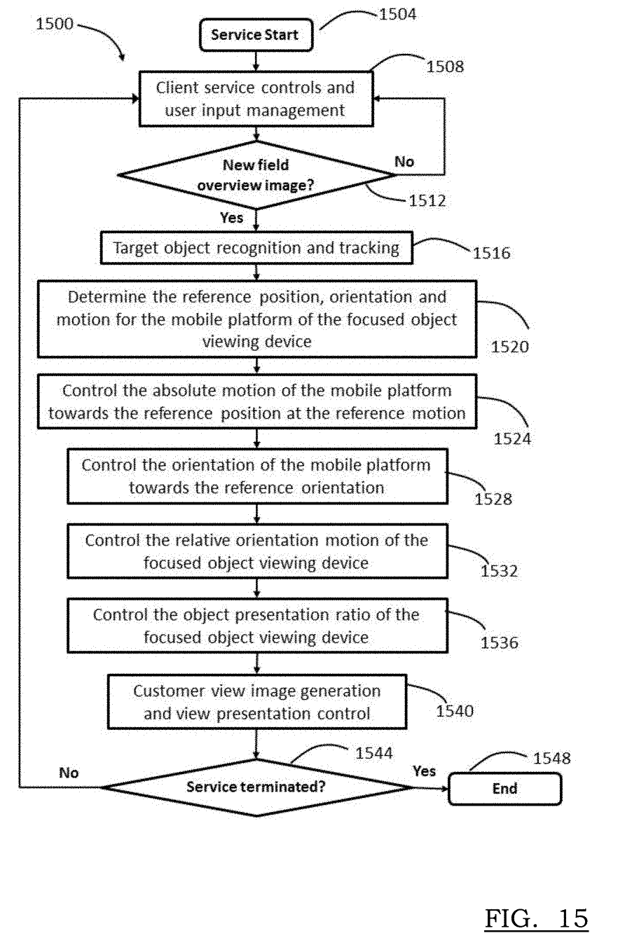

With reference to FIG. 15, a method for automatic view presentation control using focused object viewing device on a mobile platform is illustrated according to one or more embodiments and is generally referenced by numeral 1500. This method realizes a further advanced control functions of the view presentation service center 30. After service starts at step 1504, this method first carries out client service control and user input management at step 1508. The method 1500 next checks on if there is a newly updated field overview image received from the field overviewing device 26 at step 1512. If not, the method 1500 will continue waiting for field overview image update while watching on client service control and user input management at step 1508. Once a field overview image update condition is satisfied at step 1512, the method 1500 next starts on generating a new high resolution field overview image from the available one or a plural of camera view images. In the generated field overview image, general objects are spotted and their position and size are evaluated inside the field overview image at step 1516. This step is the same as step 1016 in the method 1000 illustrated in FIG. 3. The position and motion in the field coordinate system 308 for each of the target objects are also determined in this step.

Based on the target object's position and motion estimation data, the view presentation service center determines the reference position and motion of the mobile platform at step 1520. The view presentation service center may further estimate the facing direction of the target object to determine a reference orientation of the mobile platform. After that, the view presentation service center controls the absolute motion of the mobile platform towards the reference position and at a motion substantially close to the determined reference motion at step 1524. The view presentation service center further controls the orientation of the mobile platform towards the reference orientation at step 1528. Next, the view presentation service center controls the relative orientation motion, including pan and tilt angular motions, of the PTZ camera such that the resulted aim-point motion in the activity field follows the target object closely and at substantially the same velocity at step 1532. Based on the estimated object's size in the PTZ camera view, the method 1500 next controls the object view presentation ratio of the focused object viewing device 42 to achieve a reference object view presentation ratio at step 1536. The view image of the PTZ camera is then processed by the view presentation service center to generate customer view image at step 1540. Connected service users have the option to choose the individually focused target object view from the focused object viewing device or the extracted view from the field overview image as the final customer view image to be transmitted and displayed on user's view presentation device.

The service method 1500 continues from step 1544 to step 1508 to repeat the service processing steps if the connected view navigation service is not terminated. Otherwise, it stops at step 1548. The service method illustrated in FIG. 15 only serves to present a minimal level of processing steps that the invented automatic object tracking view presentation service system comprises. In applications, service functions inside a realization of the invented view presentation service system 10 may take different sequences and the executions of certain functions can be independent or in parallel to the rest of function executions.

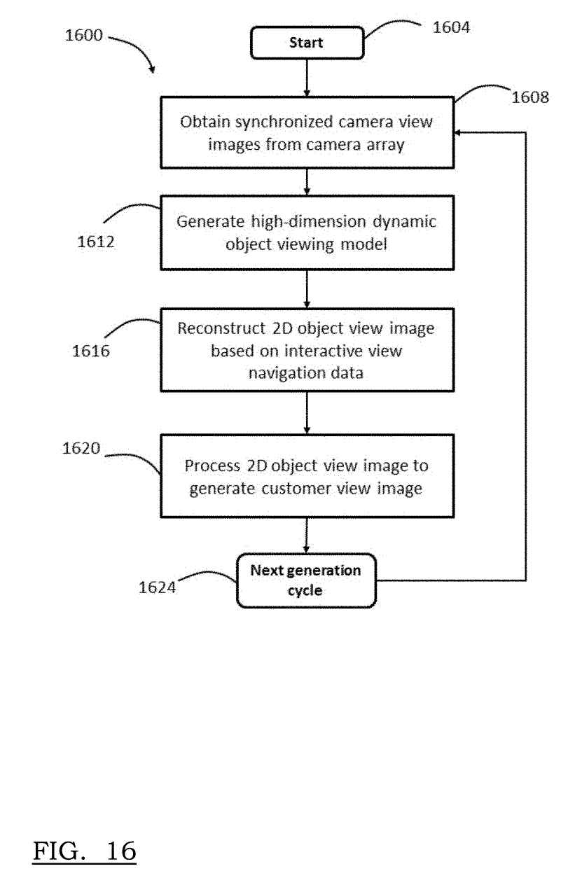

With reference to FIG. 16 a method for automatic view presentation control with camera array is illustrated according to one or more embodiments and is generally referenced by numeral 1600. The method 1600 starts at step 1604. At the first execution step 1608, synchronized camera view images are obtained from each of the unit camera devices in the camera array 704. High-dimension dynamic object viewing model is then generated from the synchronized camera view images at step 1612. Exemplary high-dimension dynamic object viewing models include but not limited to 360-degree object view, 3D/4D object view, etc. After this, the view presentation service center can reconstruct a 2D object view image from the high-dimension dynamic object viewing model based on interactive view navigation data received from each connected user to produce final customer view image at step 1616. The 2D object view image is then further processed to generate the final customer view image at step 1620. The method 1600 repetitively generates customer view image by executing steps from step 1608 to step 1620. As a result, customer view video is transmitted and displayed to user's view presentation device.

After a new field overview image is generated, an Object Recognition and Locating (ORL) function first scans through the field overview image and it locates all candidate general objects with a rectangle envelop enclosing each of the candidate general objects tightly to define its position and size. Feature based support vector machine methods and neural network models are typically used in this step for general object spotting and locating. The object features used in this step are general object features like histogram of oriented gradient, object image template, characteristic points, etc. Next, for each of the general objects located, the ORL function extracts and processes all the specific features that will be used in target object recognition step. Such specific features include but not limited to color histogram, local binary pattern, optical flow, object image contour template, and object image texture, etc. Machine learning methods and neural network are typically used in this feature learning process.

For each connected user, based on known target object's feature information, the target object is recognized by evaluating normalized similarity metrics between the candidate general objects and the target object. Typical similarity metric comprises but not limited to the evaluations on the position displacement, the template matching score, the characteristic point matching score, and the characteristic feature histogram difference, etc. The candidate general object that achieves the highest score on overall weighted similarity measures is set as the target object. After the recognition, all the newly process target object features are learned by the ORL function to adopt new appearance and characteristic variations to better support future target object recognition.

Next, the evaluated position and size of the recognized general object are sent to view presentation service center 30 to synthesize for target object' motion data. Digital signal filtering algorithms are implemented. Embodiments of the digital signal filtering algorithms include but not limited to Kalman filter, particle filter, moving average filter, and Bayesian filter algorithms. After the information fusion process, information about the position and motion of the target object is derived and such information include the estimated object position, the predicted object position in the next execution time cycle, the estimated object velocity, and the estimation object size. The estimated object position and the estimated object size are used as the identified position and size of the target object in subsequent customer view frame determination. Object's facing direction may also be determined out of this process.

After a new field overview image is generated, and the identified position and size of the target object have been obtained. The relative position and sizing parameters is first loaded for each of the connected uses. The final position and size of the customer view frame are computed as: w_{f}=wₒ+e_{w}; h_{f}=hₒ+eₕ; Wᵥ=Wₜ·s_{w}; Hᵥ=Hₜ·sₕ. When shape deflection and rotation are involved in the determination of the customer view frame, the position and sizing parameters are next further adjusted based on the rotation angle and deflection ratio to finalize the position and size of the customer view frame.

In some embodiment of the system 10, a positioning device is used to provide position measurement for the target object. The positioning device first comprises a centralized unit residing in the view presentation service center for receiving and processing individual target object's positioning measurement. The positioning device next comprises distributed sensor unit that is attached to each of the target object. Such position measurement tells the position of the target object at a time instant in the field coordinate system. After transforming the position measured to a corresponding position in the field overview image coordinate system, the position measurement assists the ORL function in target object recognition by limiting the candidates to only the general objects near the measured target object's position within a certain distance threshold. In this way, the object recognition can be largely facilitated with better recognition accuracy.

The identified size of the target object is next obtained as the size of a general object recognized to be the target object in a field overview image that is associated to the position measurement. The field overview image that is associated to the position measurement is the field overview image that is generated from camera view images that are captured at time instants sufficiently close to the time instant the position measurement is taken such that the field overview image and the position measurement are regarded as containing the information about the activity field 14 at the same time. Such association methods are called time series association. In exemplary online applications, the position measurement is associated to the most recent field overview image generated. When the position measurement time step and the field overview image generation cycle time are known, the frame sequence association method can be used by matching the sequence number of the position measurement to the frame sequence label of the field overview image. The field overview image that is associated to the position measurement is also used subsequently to extract the image data for generating the customer view image.

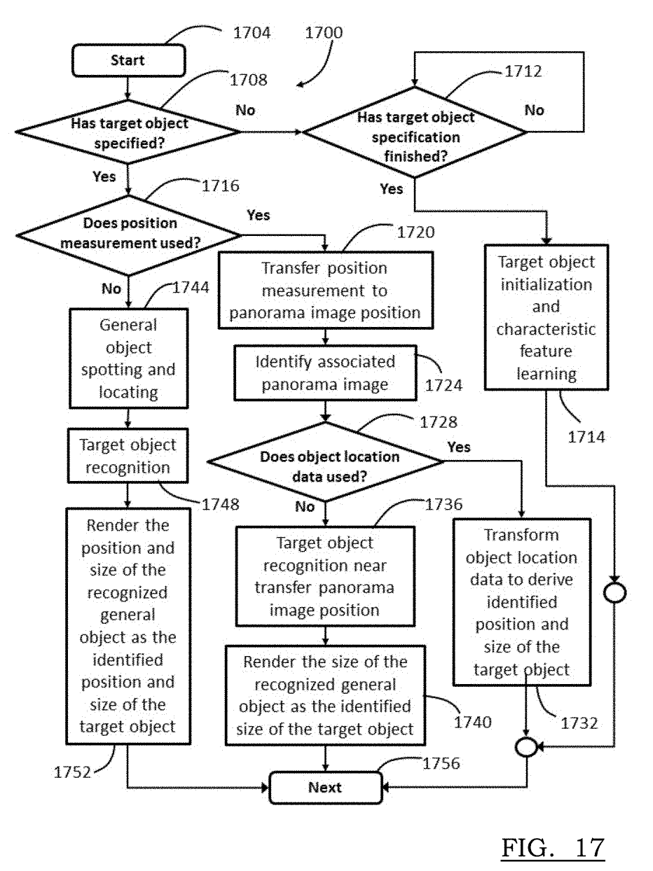

With reference to FIG. 17, a method for determining the identified position and size of the target object is illustrated according to one or more embodiments and is generally referenced by numeral 1700. After starting at step 1704, the method 1700 first checks on if a target object has been specified by the connected user at step 1708. If the target object has not been specified, the method will wait for user's input on target object specification command at step 1712. Once a target object specification command is received, the method goes to step 1714 to initialize the target object by rendering the specified general object's envelop position and size as the initial identified position and size for the target object. Furthermore, characteristic features are extracted from the image of the specified general object and learned by the ORL function to support target object recognition in future field overview image generation cycles.

If checked that the target object has been specified at step 1708, the method 1700 further checks on if position measurement from either a positioning device or an object locating device is used in target object position and size identification system at step 1716. If used, the position measurement is transformed to the field overview image coordinate system 408 to obtain the identified position of the target object at step 1720. The associated field overview image is also identified at step 1724. The method 1700 next checks if an object locating device 540 is available and the object location data is used at step 1728. When used, step 1732 is carried out to transform the object location data to the field overview image coordinate system 408 to derive the corresponding identified position and size of the target object. If the object locating device 540 is not used, then step 1736 is carried out after step 1728 to recognize the target object among all candidate general objects near the field overview image position corresponding to the position measurement. The position and size of the recognized general object is then rendered as the identified position and size for the target object at step 1740. Digital signal filtering may be used in this rendering process. The object envelop is typically used directly to represent the object position and size in this step. At step 1716, if checked that there is no position measurement used, the method 1700 next scans through the field overview image or a sub-region of the field overview image surrounding the previous identified target object position to spot and locate all candidate general objects at step 1744. Target object is then recognized from the candidates based on similarity evaluation on characteristic features between the extracted feature from the candidates and the previously learned feature information about the target object at 1748. The newly extracted feature information is further learned by the ORL function after a general object is confirmed as the target object. After that, the position and size of the recognized general object are rendered as the identified position and size for the target object at 1752. Digital signal filtering may be used in this rendering process. This round of processing ends at step 1756. In every field overview image generation cycle, the method 1700 is repeated for each of the connected users to determine the identified position and size for their individually specified target object.

As demonstrated by the embodiments described above, the methods and systems of the present invention provide advantages over the prior art by integrating camera systems and displaying devices through automatic object tracking view presentation control methods and communication systems. The resulted service system is able to provide applications enabling automatic object tracking view presentation inside a commonly shared field overview to support individually specified object following view presentation service to crowd users. The data transmission is minimized when sending only the customer view image to each of the public users within communication throughput limit.

While the best mode has been described in detail, those familiar with the art will recognize various alternative designs and embodiments within the scope of the following claims. Additionally, the features of various implementing embodiments may be combined to form further embodiments of the invention. While various embodiments may have been described as providing advantages or being preferred over other embodiments or prior art implementations with respect to one or more desired characteristics, those of ordinary skill in the art will recognize that one or more features or characteristics may be compromised to achieve desired system attributes, which depend on the specific application and implementation. These attributes may include, but are not limited to: cost, strength, durability, life cycle cost, marketability, appearance, packaging, size, serviceability, weight, manufacturability, ease of assembly, etc. The embodiments described herein that are described as less desirable than other embodiments or prior art implementations with respect to one or more characteristics are not outside the scope of the disclosure and may be desirable for particular applications. Additionally, the features of various implementing embodiments may be combined to form further embodiments of the invention.

What is claimed is:

1. A system for providing automatic object tracking view presentation service comprising:
a field overviewing device;
a telescopic mast device;
a networked communication device;
a power supply device;
a computerized view presentation service center that further comprising:
memory, configure to store a program of instructions and data;
at least one processor operably coupled to said memory, and said networked communication device, and said field overviewing device to execute said program of instructions, wherein when said program of instruction is executed, carries out the steps of:
generating field overview image from said field overviewing device;
for each connected user, determining a customer view frame inside said field overview image such that the image of a target object specified by said each connected user is sufficiently covered and centered inside the overview image area defined by said customer view frame; and wherein said customer view frame is determined based on view navigation data comprising the identified position and size of said target object and the received user inputs;
extracting image data in memory locations that correspond to the image area of said field overview image inside said customer view frame;
processing said extracted image data to generate a customer view image;
transmitting said customer view image through said networked communication device to at least one user's view presentation device.

2. The system of claim 1, wherein said field overviewing device comprises a zoom control device to control the field-of-view of said field overview image.

3. The system of claim 1, wherein said field overviewing device is a camera array device, and wherein said program of instruction is executed, further carries out the steps of:
obtaining synchronized camera view streams from said camera array device;
generating at least one field overview image from said synchronized camera view streams using overview image construction method comprising at least one of:
panorama image stitching method;
3D view reconstruction method.

4. The system of claim 1, wherein said telescopic mast device has mast base and support comprising at least one of:
fixed mast base and support;
portable mast base and support;
mobile mast base and support;
automatic mobile mast based and support with actuated motion control device.

5. The telescopic mast device of claim 1 comprises a height-control device to adjust the height of said telescopic mast device, and wherein said height of said telescopic mast device is controlled using method comprising at least one of:
a mechanical height adjustment device with manual height adjustment method;
an electro-mechanical height adjustment device with electronic and remote-controlled height adjustment method;
an electro-mechanical height adjustment device with computer program controlled height adjustment method.

6. The system of claim 1 further comprises a computer program controlled mast height control device to adjust the height of said telescopic mast device, and wherein said computerized view presentation service center further comprises at least one processor operably coupled to said computer program controlled mast height control device to execute program of instructions, carrying out the steps of:
determining the target height for said telescopic mast device;
obtaining the present height measurement of said telescopic mast device;
controlling the elevation of said telescopic mast device to reach said determined target height automatically;
calibrating the positioning relationship parameters between the pixel position coordinate system of said field overview image and the field coordinate system.

7. The system of claim 1, wherein said networked communication device is a wireless communication device comprising a network switch and at least one WIFI access point.

8. The wireless communication device of claim 4 further connects to Internet, and wherein said computerized view presentation service center further executes program of instruction to carry out operations including:
user account and user data management;
remote object viewing presentation;
network based view presentation data storage;
performance data analysis, storage and sharing.

9. The system of claim 1, wherein said power supply device provide electric power to all the electronic devices using power supply system comprising at least one of:
electric power grid based power supply system;
battery based power supply system;
generator based power supply system.

10. The system of claim 1 further comprises a pan-tilt unit to adjust the orientation of said field overviewing device, and wherein said orientation of said field overviewing device is controlled by adjusting the pan angle and tilt angle of said pan-tilt unit using method comprising at least one of:
a mechanical pan-tilt unit with manual pan angle and tilt angle adjustment method;
an electro-mechanical pan-tilt unit with electronic and remote-controlled pan angle and tilt angle adjustment method;
an electro-mechanical pan-tilt unit with computer program controlled pan angle and tilt angle adjustment method.

11. The pan-tilt unit of claim 10 further comprises a rotation device to adjust the rotation of said field overviewing device, and wherein said rotation of said field overviewing device is controlled by adjusting the rotation angle of said pan-tilt unit using method comprising at least one of:
a mechanical pan-tilt unit with manual rotation angle adjustment method;
an electro-mechanical pan-tilt unit with electronic and remote-controlled rotation angle adjustment method;
an electro-mechanical pan-tilt unit with computer program controlled rotation angle adjustment method.

12. The system of claim 1 further comprises an electro-mechanical pan-tilt unit with computer program controlled rotation device to control said rotation of said field overviewing device, and wherein said computerized view presentation service center further comprises at least one processor operably coupled to said computer program controlled rotation device to execute program of instructions, carrying out the steps of:
determining the target rotation angle for said pan-tilt unit;
obtaining the present rotation angle measurements of said pan-tilt unit;
controlling the rotation angle of said pan-tilt unit to reach said target rotation angle automatically;
calibrating the positioning relationship parameters between the pixel position coordinate system of said field overview image and the field coordinate system.

13. The system of claim 1 further comprises an electro-mechanical pan-tilt unit with computer program controlled orientation adjustment device to control said orientation of said field overviewing device, and wherein said computerized view presentation service center further comprises at least one processor operably coupled to said electro-mechanical pan-tilt unit to execute program of instructions, carrying out the steps of:
determining the target pan angle and target tilt angle for said pan-tilt unit;
obtaining the present pan angle and tilt angle measurements of said pan-tilt unit;
controlling the pan angle and tilt angle of said pan-tilt unit to reach said target pan angle and target tilt angle automatically;
calibrating the positioning relationship parameters between the pixel position coordinate system of said field overview image and the field coordinate system.

14. The system of claim 1 further comprises at least one focused object viewing device, and wherein said computerized view presentation service center further comprises at least one processor operably coupled to said focused object viewing device to execute program of instructions, carrying out the steps of:
recognizing and tracking said target object in said field overview image;
determining the position of said target object in an activity field and computing the motion parameters of said target object;
controlling the orientation motion of said focused object viewing device based on the position and motion of said target object such that the aim-point of said focused object viewing device follows said target object in said activity field closely and at substantially the same velocity as that of said target object;
controlling the field of view of said focused object viewing device to achieve a reference object presentation ratio;
processing view image from said focused object viewing device to generate said customer view image.

15. The focused object viewing device of claim 14 further comprises a mobile platform, and wherein said computerized view presentation service center further comprises at least one processor operably coupled to said mobile platform of said focused object viewing device to execute program of instructions, carrying out the steps of:
determining the reference position, orientation and motion for said mobile platform of said focused object viewing device based on the position and motion of said target object in said activity field;
controlling the absolute motion of said mobile platform towards said reference position at a motion substantially close to the determined reference motion;
controlling the orientation of said mobile platform towards said reference orientation;
controlling the relative orientation motion of said focused object viewing device based on the position and motion of said target object such that the resulted motion of said aim-point of said focused object viewing device follows said target object in said activity field closely and at substantially the same velocity as that of said target object.

16. The focused object viewing device of claim 14 comprises a camera array, and wherein said computerized view presentation service center further comprises at least one processor operably coupled to said camera array of said focused object viewing device to execute program of instructions, carrying out the steps of:
obtaining synchronized camera view images from said camera array;
generating high-dimension dynamic object viewing model from said synchronized camera view images;
for each connected user, reconstructing a 2D object view image from said high-dimension dynamic object viewing model based on interactive view navigation data;
processing said reconstructed 2D object image to generate a customer view image.

17. The system of claim 1 further comprises a positioning device that generates position measurement to locate said target object for said each connected user; and wherein said computerized view presentation service center further comprises at least one processor operably coupled to said positioning device to execute program of instructions, carrying out the steps of:
obtaining position measurement of said target object in an activity field from said positioning device;
determining the position of said target object and computing the motion parameters of said target object in an activity field;
generating said view navigation data further based on said determined position of said target object.

18. The computerized view presentation service center of claim 17 that comprises at least one processor operably coupled to said positioning device to execute program of instructions, further carrying out the steps of:
locating at least one general object at a position corresponding to said position measurement in said field overview image that is associated to said position measurement;
recognizing one of said at least one general object as said target object for said each connected user;
refining the position of said recognized target object and evaluating the size of said recognized target object;
generating said view navigation data based on refined position and evaluated size of said target object.

19. The system of claim 1 further comprises a plural of said field overviewing devices, and wherein said computerized view presentation service center further comprises at least one processor operably coupled to said plural of said field overviewing devices to execute program of instructions, carrying out the steps of:
obtaining synchronized field overviewing video streams from said plural of said field overviewing devices;
generating high-dimension dynamic field overviewing model from said synchronized field overviewing video streams;
for each connected user, reconstructing a 2D object view image from said high-dimension dynamic field overviewing model based on said customer view frame;
processing said reconstructed 2D object image to generate a customer view image.
